(19) United States
(12) Patent Application Publication
(10) Pub. No.: US 2023/0053913 A1
(43) Pub. Date: Feb. 23, 2023

(54) TAILORING A MULTI-CHANNEL HELP DESK ENVIRONMENT BASED ON MACHINE LEARNING MODELS

(71) Applicant: International Business Machines Corporation, Armonk, NY (US)

(72) Inventors: Carlos Demetrio De Souza, Campinas (BR); Thiago Bianchi, Sao Carlos (BR); Edinar Lopes de Aquino Junior, Sao Paulo (BR); Adriana Pellegrini Furnielis, Valinhos (BR); Andre Barros Venancio, Sao Paulo (BR)

(21) Appl. No.: 17/407,321

(22) Filed: Aug. 20, 2021

(51) Int. Cl. G06Q 30/00; G06N 20/00; G06F 16/9535; G06K 9/62; G06N 3/12

(52) U.S. Cl. CPC G06Q 30/016; G06N 20/00; G06F 16/9535; G06K 9/6262; G06K 9/6256; G06K 9/6218; G06N 3/12

(57) ABSTRACT

Computer-implemented methods of training machine learning models and using the machine learning models for tailoring a multi-channel help desk environment. One or more computers train a machine learning model of selecting best attendance channels for respective customer clusters and for respective issue clusters. One or more computers train machine learning models of tailoring respective attendance channel types. One or more computers employ the machine learning models to determine a best attendance channel for resolving an information technology problem of a user and to predict channel tailoring characteristics for the best attendance channel. One or more computers employ genetic algorithm operators to determine a random attendance channel with random tailoring characteristics. One or more computer use random routing to route the user to one of the best attendance channel and the random attendance channel, avoiding undesired bias favorable toward the best attendance channel.

### BACKGROUND

The present invention relates generally to configuring a multi-channel help desk environment, and more particularly to training machine learning models and using the machine learning model for tailoring a multi-channel help desk environment.

Organizations are under pressure to provide a consumer-like support experience to their members across a variety of channels and for a growing range of devices to resolve service issues more quickly and optimize the end-user experience. Current support services deliver a personalized experience across multiple channels for more consistent, exceptional end-user support.

### SUMMARY

In one aspect, a computer-implemented method for training machine learning models for tailoring a multi-channel help desk environment is provided. The method includes analyzing customer feedback on attendance channels to obtain parameterized feedback metrics. The method further includes assembling a dataset including ticket records associated with the attendance channels and the parameterized feedback metrics. The method further includes augmenting the dataset by replacing customer identifications in the dataset with respective cluster centroids of customer clusters. The method further includes augmenting the dataset by replacing information technology (IT) descriptions in the dataset with respective cluster centroids of issue clusters. The method further includes training a machine learning model of selecting best attendance channels for respective ones of the customer clusters and for respective ones of the issue clusters, using an augmented dataset. The method further includes enhancing the augmented dataset by adding channel tailoring characteristics to the augmented dataset. The method further includes dividing an enhanced dataset into respective partitions for respective attendance channel types. The method further includes training machine learning models of tailoring the respective attendance channel types, using the respective partitions of the enhanced dataset.

In another aspect, a computer-implemented method for tailoring a multi-channel help desk environment based on machine learning models is provided. The method includes, in response to receiving a request from a user for resolving an information technology (IT) problem, determining a customer cluster of the user. The method further includes determining an issue cluster of the IT problem. The method further includes employing a machine learning model of selecting best attendance channels to determine a best attendance channel for the user resolving the IT problem. The method further includes employing a machine learning model of tailoring respective attendance channel types to predict channel tailoring characteristics for the best attendance channel. The method further includes employing genetic algorithm operators to determine a random attendance channel with random tailoring characteristics. The method further includes using random routing to route the user to one of the best attendance channel and the random attendance channel, routing the user to the random attendance channel with a predetermined probability. In the method, using the random routing avoids undesired bias favorable toward the best attendance channel.

### BRIEF DESCRIPTION OF THE SEVERAL VIEWS OF THE DRAWINGS

FIG. 1 is a systematic diagram illustrating a system for tailoring a multi-channel help desk environment based on machine learning models, in accordance with one embodiment of the present invention.

FIG. 2 is a flowchart showing operational steps of analyzing customer data and information technology service management (ITSM) data, in accordance with one embodiment of the present invention.

FIG. 3 is a flowchart showing operational steps of training machine learning models for tailoring a multi-channel help desk environment, in accordance with one embodiment of the present invention.

FIG. 4(A) and FIG. 4(B) present a flowchart showing operational steps of tailoring a multi-channel help desk environment, in accordance with one embodiment of the present invention.

FIG. 5 is a diagram illustrating components of a server, in accordance with one embodiment of the present invention.

FIG. 6 depicts a cloud computing environment, in accordance with one embodiment of the present invention.

FIG. 7 depicts abstraction model layers in a cloud computing environment, in accordance with one embodiment of the present invention.

### DETAILED DESCRIPTION

Embodiments of the present invention disclose a system and method for automatically routing help desk requests by predicting the best attendance channel and its respective tailoring configurations. In the system and method, selecting and configuring multi-channel help desk channels are based on customer hardware and software inventory, customer profile, workforce profile, support tickets, and user feedback.

The present invention is used to tailor a help desk attendance channel to improve the user experience and effectiveness. Users have no idea about the best help desk channel to solve their problem; therefore, selecting the best help desk channel by the proposed system and method increases the probability of users to solve their issues and improve their effectiveness and engagement rates.

In embodiments of the present invention, the proposed system and method obtain customer profiles by clustering workforce profiles of information technology (IT) users. The workforce profiles include academic background, professional experience (e.g., how many years working at the company and/or at the current department), technical training, technical/professional certifications, and job responsibilities of the IT users.

In embodiments of the present invention, the proposed system and method obtain problem profiles by clustering IT tickets. The problem profiles include information about affected software (e.g., operational systems, productivity suites, and off-the-shelf software) and affected hardware (e.g., device types, manufacturers, models, and remaining warranty periods) platforms of the IT users.

In embodiments of the present invention, the proposed system and method involve machine learning models. The proposed system and method train a channel routing classifier model in a training phase and apply the channel routing classifier model to tailoring a multi-channel help desk environment. The channel routing classifier model correlates a customer profile, a problem profile, and a feedback rate for an attendance or support channel. The proposed system and method further train a channel tailoring prediction model and apply the channel tailoring prediction model to tailoring a multi-channel help desk environment. The channel tailoring prediction model correlates a customer profile, a problem profile, a feedback rate, and an attendance or support channel with a channel tailoring configuration.

In embodiments of the present invention, the proposed system and method reduces the training bias of the above-mentioned machine learning trained models by replacing the customer data with customer profiles and replacing problem data with problems profiles.

In embodiments of the present invention, the proposed system and method applies genetic algorithm operators for computing compute random solutions to avoid undesired bias in the above-mentioned machine learning trained models. The genetic algorithm operators are randomized search algorithms that have been developed in an effort to imitate the mechanics of natural selection and natural genetics. The genetic algorithm operators operate on string structures which are evolving in time according to the rule of survival of the fittest by using a randomized yet structured information exchange. Thus, in every generation, a new set of strings is created, using parts of the fittest members of the old set. Therefore, by employing such genetic algorithm operators, it is possible to obtain different combinations of attendance channels with their associated characteristics.

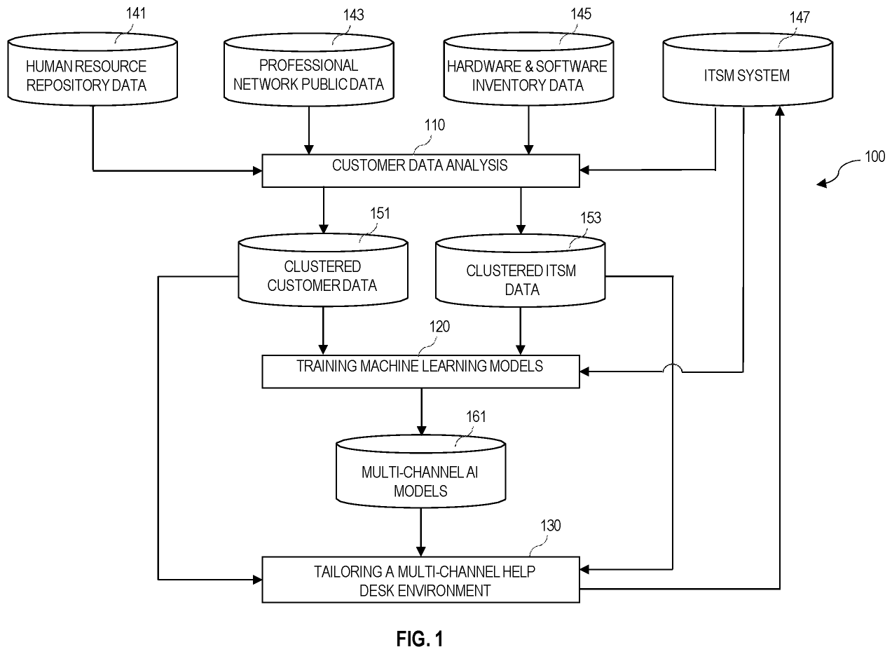

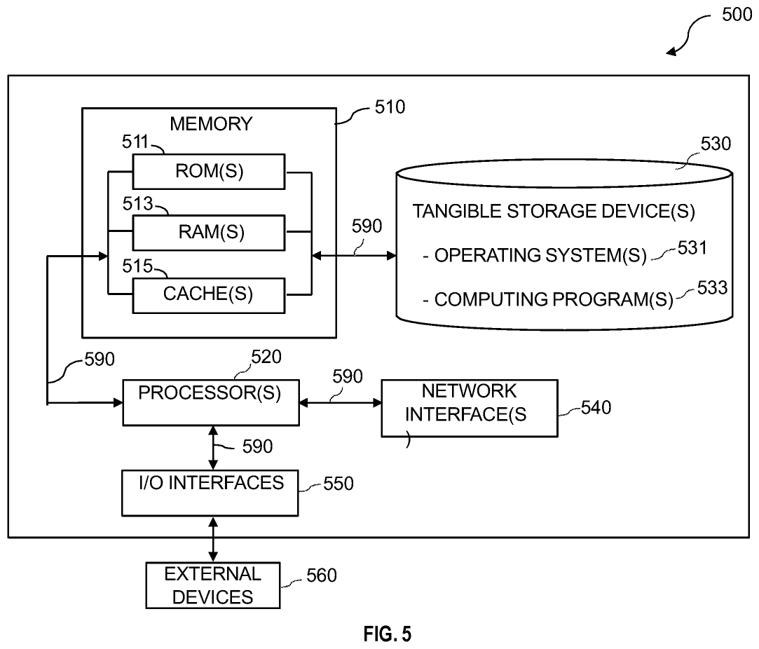

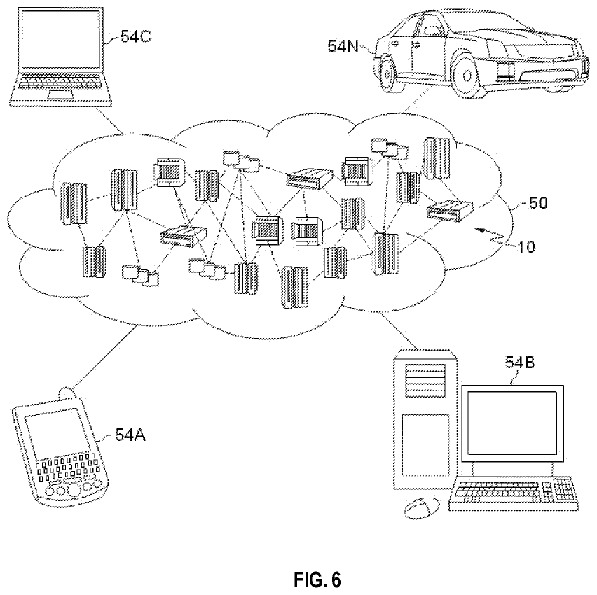

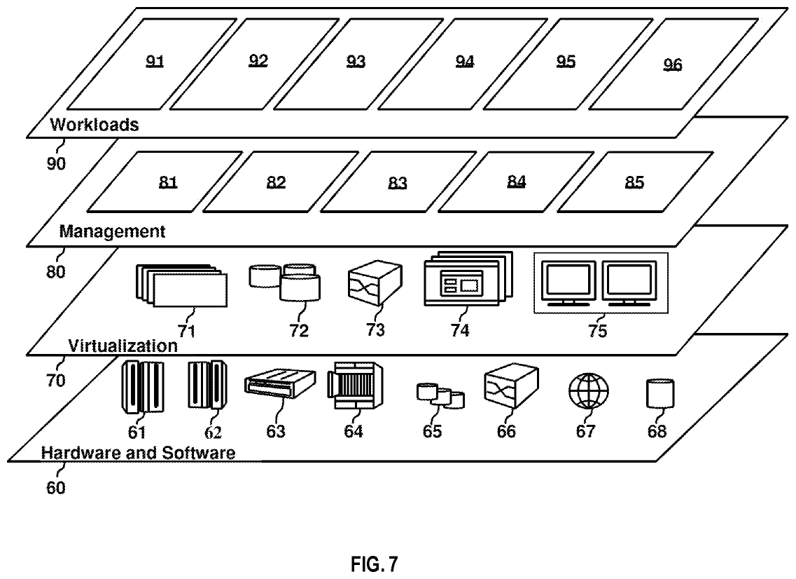

FIG. 1 is a systematic diagram illustrating system 100 for tailoring a multi-channel help desk environment based on machine learning models, in accordance with one embodiment of the present invention. System 100 includes three primary components: customer data analysis 110, training machine learning models 120, and tailoring a multi-channel help desk environment 130. System 100 may be implemented on one or more computing devices or servers. A computing device or server is described in more detail in later paragraphs with reference to FIG. 5. System 100 may be implemented in a cloud computing environment. The cloud computing environment is described in more detail in later paragraphs with reference to FIG. 6 and FIG. 7.

Customer data analysis 110 (a component in system 100) gathers and clusters detailed information regarding the workforces and information technology (IT) environments of customers/users from multiple sources. The multiple sources include databases: human resource repository data 141, professional network public data 143, hardware & software inventory data 145, and information technology service management (ITSM) system 147. From the multiple resources, customer data analysis 110 gathers information about workforce profiles. A workforce profile of an employee/customer/user includes, for example, employee quantity, employee academic background, years with the company, years at the current department, previous departments, actual and previous job roles and job activities, technical certifications, profession level, technical training, projects developed, and so on. Customer data analysis 110 further gathers information about IT landscapes. For example, an IT landscape for an employee/customer/user includes applications, tools, and devices used by the employee/customer/user; information about hardware includes desktop computers, laptops, mobile devices, specialized devices, how old those devices are, and warranty coverage; information about software includes what applications are used by each employee, what are required at each department, what are exclusive of some areas, installed versions, and license limitations; information about access management includes existing user identifications (IDs) or profiles, permissions or privilege, account status, and password policy. From the multiple resources (more specifically ITSM system 147), customer data analysis 110 further gathers historical data about IT tickets. For example, the historical data about IT tickets includes tickets by issue and type (hardware, software, access-related, how-to inquiries), users, affected devices, channels of support, how long has been the telephone calls, required time to solve, a resolution ratio in each channel, time of the day, day of the week, and so on. From the multiple resources (more specifically ITSM system 147), customer data analysis 110 further gathers information of open issues.

Customer data analysis 110 clusters the detailed information gathered as mentioned above. Customer data analysis 110 stores clustered information in databases: clustered customer data 151 and clustered ITSM data 153.

Training machine learning models 120 (a component in system 100) uses data from clustered customer data 151, clustered ITSM data 153, and ITSM system 147 as training data to train the channel routing classifier model and the channel tailoring prediction model. Training machine learning models 120 stores the above mentioned machine learning trained models in a database: multi-channel artificial intelligence (AI) models 161.

Training machine learning models 120 correlates the data from clustered customer data 151, clustered ITSM data 153, and ITSM system 147. For example, training machine learning models 120 identifies how easy it is to describe or identify an issue and a root cause, including the telephone call duration of each issue type, tickets opened by self-service forms and routed to wrong solvers, discrepancies between the ticket symptom category and the resolution category. For example, training machine learning models 120 further identifies how much guidance a user needs and how many data fields is required for a request type of a user. For example, training machine learning models 120 further identifies how long it took to solve an issue, determining whether the issue has been solved on a call or routed to other teams. For example, training machine learning models 120 further identifies the confidence level of the user; when describing the issue (in self-service web-based forms, for instance), the user's voice tone demonstrates confidence about the issue (as the user instructs the solution team) or uncertainty (giving fewer details, no assertions, and so on). For example, training machine learning models 120 further identifies user's satisfaction with each issue and each channel, using the net promoter score (NPS), the customer satisfaction (CSAT), and the customer effort score (CES).

Training machine learning models 120 trains a model for selecting a best attendance channel (or the channel routing classifier model) based on a user and an issue. For example, in selecting the best attendance channel, following parameters are considered: user satisfaction rate, cost to solve the problem, time to solve the problem, first call resolution ratio, ticket quality (e.g., routed to wrong solution group, missing information, reopened by user, refused/canceled by solution group, etc), users drop/abandon ratio (e.g., user drops the call, exits the chatbot without solution).

Training machine learning models 120 trains a model for configuring or tailoring a channel (or the channel tailoring prediction model). For example, the model for configuring or tailoring a channel includes the following factors: employee technical background and the issue (a customer cluster and an issue cluster), choosing the best attendance skill for the issue, chatbot detail configuration (skipping or reinforcing basic questions), changing the web catalog (adding or removing advanced and required fields), or routing to expert analysts.

Training machine learning models 120 further trains a model for providing feedback to system 100. For example, the model for providing the feedback measures metrics (e.g., user satisfaction, cost to solve, time to open a ticket, time to solve the issue, and ticket quality) compared to users in the same cluster.

Upon a request of an user for resolving an IT issue (or problem), tailoring a multi-channel help desk environment 130 (a component in system 100) retrieves a customer profile for a customer cluster to which the user belongs, from the database of clustered customer data 151. Tailoring a multi-channel help desk environment 130 retrieves a problem profile for a issue cluster to which the IT issue (or problem) belongs, from the database of clustered ITSM information 153. Tailoring a multi-channel help desk environment 130 uses the channel routing classifier model in multi-channel artificial intelligence (AI) models 161 to determine a best attendance channel. Tailoring a multi-channel help desk environment 130 further uses a channel tailoring prediction model for the best attendance channel in multi-channel artificial intelligence (AI) models 161 to predict channel tailoring characteristics for the best attendance channel. Tailoring a multi-channel help desk environment 130 further uses genetic algorithm operators to determine a random attendance channel with random tailoring characteristics.

Tailoring a multi-channel help desk environment 130 determines a best attendance channel and a random attendance channel for the specific IT issue or problem of specific the user. To avoid undesired bias favorable toward the best attendance channel, tailoring a multi-channel help desk environment 130 uses random routing; the user is routed to the random attendance channel with a predetermined probability. For example, the user is routed to the random attendance channel with 30% probability.

Tailoring a multi-channel help desk environment 130 may route the user to one of the best attendance channel and the random attendance channel. After one of the channels is used by the user, tailoring a multi-channel help desk environment 130 compares feedback on the best attendance channel and the random attendance channel. In response to determining that the feedback on the best attendance channel is more positive than the feedback on the random attendance channel (or the feedback on the best attendance channel is better than the feedback on the random attendance channel), tailoring a multi-channel help desk environment 130 provides positive reinforcement for the channel routing classifier model; as a result, the best attendance channel keeps receiving the highest feedback rates, the new positive feedback will increase its score. In response to determining that the feedback on the random attendance channel is more positive than the feedback on the best attendance channel (or the feedback on the random attendance channel is better than the feedback on the best attendance channel), tailoring a multi-channel help desk environment 130 records in ITSM system 147 the positive feedback on the random attendance channel. The recorded positive feedback on the random attendance channel may be used for retraining the channel routing classifier model.

For a request of an user for resolving an IT issue (or problem), tailoring a multi-channel help desk environment 130 determines what support channel are more successful for a customer cluster to which the user belongs; for example, a customer cluster may include employees in one department, users using a set of apps, or users with a same seniority level). Tailoring a multi-channel help desk environment 130 further determines what support channel is more successful for an issue cluster to which the IT issue or problem belongs. For example, a web-catalog as the support channel may be more effective for an issue cluster dealing with software SAP procedure issues, and phone calls as the support channel may be more effective for password-related issues; however, it is very complex to describe Oracle errors through phone calls as the support channel. Tailoring a multi-channel help desk environment 130 further determines what support channel is more successful to a combination of the customer cluster and the issue cluster. For example, a senior software engineer who just open a level-2 ticket may not need introductory chatbot questions; when a telecom technician reports a network problem, the technician probably has tried every possible solution and may certainly need a specialized support; an employee from a finance department asking about SAP during first 3 months may have much more how-to requests.

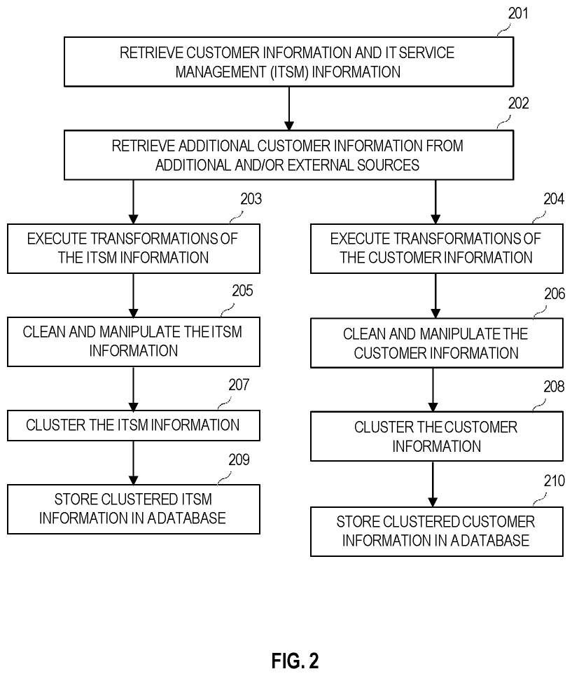

FIG. 2 is a flowchart showing operational steps of analyzing customer data and information technology service management (ITSM) data, in accordance with one embodiment of the present invention. In the embodiment shown in FIG. 1, the operational steps of analyzing customer data and ITSM data are implemented by customer data analysis 110—a component in system 100 which is hosted on one or more computing devices or servers. A computing device or server is described in more detail in later paragraphs with reference to FIG. 5. The operational steps may be implemented in a cloud computing environment. The cloud computing environment is described in more detail in later paragraphs with reference to FIG. 6 and FIG. 7.

At step 201, the one or more computing devices or servers retrieve customer information and information technology service management (ITSM) information. For example, the one or more computing devices or servers collects data from a company's internal sources. For example, in the embodiment shown in FIG. 1, the one or more computing devices or servers retrieve the information from databases: human resource repository data 141, professional network public data 143, hardware & software inventory data 145, and information technology service management (ITSM) system 147.

At step 202, the one or more computing devices or servers retrieve additional customer information from additional and/or external sources. The additional customer information includes professional network public data, such as professional certifications, skills badges, expertise assessments, work experience, and job roles at previous companies.

At step 203, the one or more computing devices or servers execute transformations of the ITSM information (which is retrieved at step 201). At this step, the one or more computing devices or servers prepare the ITSM information to be used by multi-channel artificial intelligence (AI) models for tailoring a multi-channel help desk environment, by removing unused or repeated columns, correcting data types, replacing missing values, expanding timestamps, fixing typos, and processing other transformations (such as correlating issues/problems and resolution categories, normalizing issue descriptions, and identifying solution groups).

In parallel to step 203, at step 204, the one or more computing devices or servers execute transformations of the customer information (which is retrieved at step 201 and step 202). Similarly, the one or more computing devices or servers prepare the customer information to be used by multi-channel artificial intelligence (AI) models for tailoring a multi-channel help desk environment. The transformations include removing unused and repeated columns, correcting data types, replacing missing values, expanding timestamps, and processing other transformations (such as normalizing job role descriptions and job responsibilities, correlating professional levels and expertise using technical certifications, and so on).

After step 203, at step 205, the one or more computing devices or servers clean and manipulate the ITSM information. At this step, the one or more computing devices or servers deal with missing values and low-frequency outliers, removing or replacing them with mean, mode or median values. The one or more computing devices or servers also employs commonly known natural language processing (NLP) techniques (e.g., stop words removal, stemming, term frequency, inverse document frequency, and others).

After step 205, at step 207, the one or more computing devices or servers cluster the ITSM information. At this step, the one or more computing devices or servers employ well-known unsupervised machine learning techniques (e.g., k-means and density-based spatial clustering of applications with noise (DBSCAN)) to obtain problem profiles for issue clusters. The problem profiles for the issue clusters highlight patterns, such as tickets related to a particular application in a distinct department, types of issues reported by users during the first weeks using one specific software, and tickets opened by users through a self-service catalog.

After step 207, at step 209, the one or more computing devices or servers store clustered ITSM information in a database. For example, in the embodiment shown in FIG. 1, the one or more computing devices or servers store clustered ITSM information in clustered ITSM data 153 in system 100.

After step 204, at step 206, the one or more computing devices or servers clean and manipulate the customer information. At this step, the one or more computing devices or servers deal with missing values and low-frequency outliers, removing or replacing them with mean, mode or median values. The one or more computing devices or servers also employs commonly known natural language processing (NLP) techniques (e.g., stop words removal, stemming, term frequency, inverse document frequency, and others).

After step 206, at step 208, the one or more computing devices or servers cluster the customer information. At this step, the one or more computing devices or servers analyzes and correlate the customer information and the ITSM information to identify patterns of user attributes and IT issues. Customer profiles for customer clusters highlight these patterns. The customer profiles are obtained by employing well-known unsupervised machine learning techniques (e.g., k-means and DBSCAN) associated with similarity measures commonly adopted in textual datasets (e.g., cosine similarity, Jaccard similarity, Mahalanobis distance, and others). As an example, in a distinct department, the majority of tickets related to a particular application opened by experienced and certified employees are change requests to add or modify application features. In another example, for a specific software, the tickets opened by new users during the first 4 weeks after an installation are related to how-to queries.

After step 208, at step 210, the one or more computing devices or servers store clustered customer information in a database. For example, in the embodiment shown in FIG. 1, the one or more computing devices or servers store clustered customer information in clustered customer data 151 in system 100.

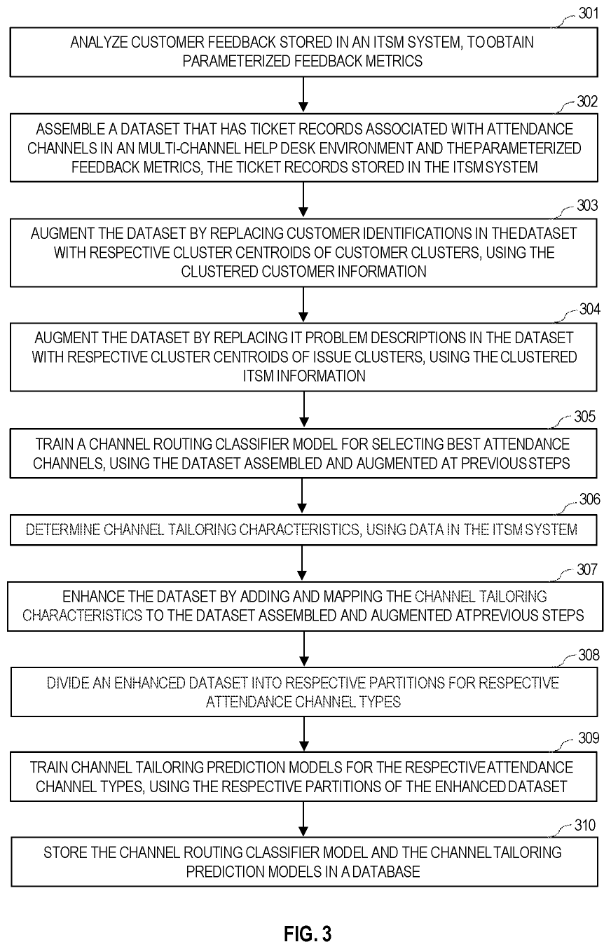

FIG. 3 is a flowchart showing operational steps of training machine learning models for tailoring a multi-channel help desk environment, in accordance with one embodiment of the present invention. In the embodiment shown in FIG. 1, the operational steps of training machine learning models are implemented by training machine learning models 120—a component in system 100 which is hosted on one or more computing devices or servers. A computing device or server is described in more detail in later paragraphs with reference to FIG. 5. The operational steps of training machine learning models may be implemented in a cloud computing environment. The cloud computing environment is described in more detail in later paragraphs with reference to FIG. 6 and FIG. 7.

At step 301, the one or more computing devices or servers analyze customer feedback stored in an information technology service management (ITSM) system, to obtain parameterized feedback metrics. In the embodiment shown in FIG. 1, the customer feedback is stored in ITSM system 147. At this step, the one or more computing devices or servers analyze implicit feedback and explicit feedback. The implicit feedback may include, for example, elapsed time to report the issue using chatbot or web catalog, duration of the phone call, and voice tone or words choice. The explicit feedback may include customer satisfaction survey rates for each issue and channel, such as the net promoter score (NPS), customer satisfaction (CSAT), and the customer effort score (CES). The one or more computing devices or servers may further analyze the user confidence level. For example, when a use describes an issue (in self-service web-based forms, for instance), the user's voice tone demonstrates confidence about the issue (as the user instructs a solution team) or uncertainty (fewer details, no assertions, and so on).

At step 302, the one or more computing devices or servers assemble a dataset that has ticket records associated with attendance channels in an multi-channel help desk environment and the parameterized feedback metrics. The ticket records are stored in the ITSM system. In the dataset, the one or more computing devices or servers correlate problem profiles, customer profiles, attendance channels, and customer feedback; the correlation is used to determine the most efficient attendance channels for different customer clusters when issues or problems are reported from specific issue clusters.

At step 303, the one or more computing devices or servers augment the dataset by replacing customer identifications in the dataset with respective cluster centroids of customer clusters. At this step, the one or more computing devices or servers use clustered customer information; in the embodiment shown in FIG. 1, the one or more computing devices or servers use a database—clustered customer data 151. At this step, the one or more computing devices or servers replace the customer data with most similar cluster centroids to reduce noise and improve the generality of the machine learning trained models.

At step 304, the one or more computing devices or servers augment the dataset by replacing information technology (IT) problem descriptions in the dataset with respective cluster centroids of issue clusters. At this step, the one or more computing devices or servers use clustered ITSM information; in the embodiment shown in FIG. 1, the one or more computing devices or servers use a database—clustered ITSM data 153. At this step, the one or more computing devices or servers replace the IT problem descriptions by their most similar cluster centroids to reduce noise and improve the generality of the machine learning trained models. In particular, at this step, the one or more computing devices or servers may also employ feature engineering techniques (e.g., principal component analysis (PCA), entropy, and others) to reduce the number of the terms to the most relevant ones.

At step 305, the one or more computing devices or server train a channel routing classifier model for selecting best attendance channels, using the dataset assembled and augmented at previous steps. The one or more computing devices or server use the dataset assembled at step 302 and augmented at steps 303 and 304. At this step, the one or more computing devices or server employ a supervised machine learning technique, such as naive Bayes, support vector machine (SVM), neural networks, to train the channel routing classifier model. In training the model, the inputs are variables that represent the customer profiles, terms that represent the problem profiles, and the historical feedback. The outputs of training the model are best attendance channels for different customer clusters and different issue clusters.

At step 306, the one or more computing devices or server determine channel tailoring characteristics, using data in the ITSM system. For example, the channel tailoring characteristics include profiles of help desk attendants, interactive voice response (IVR) menu configuration, chatbot detail levels, and web catalog form layouts. At step 307, the one or more computing devices or server enhance the dataset, by adding and mapping the channel tailoring characteristics (determined at step 306) to the dataset assembled at step 302 and augmented at steps 303 and 304.

At step 308, the one or more computing devices or server divide an enhanced dataset (enhanced at step 307) into respective partitions for respective attendance channel types. The partitions of the enhanced dataset will be used to train channel tailoring prediction models. At step 309, the one or more computing devices or server train the channel tailoring prediction models for respective attendance channel types, using the respective partitions of the enhanced dataset. At step 309, the one or more computing devices or server employ a supervised machine learning technique, such as naive Bayes, support vector machine (SVM), neural networks, to train a specific channel tailoring prediction model for each partition of the enhanced dataset. In training the model, the inputs are variables that represent the customer profiles, terms that represent the problem profiles, and the historical feedback. The outputs of training the model are channel tailoring characteristics for different attendance channel types.

At step 309, the one or more computing devices or server store the channel routing classifier model and the channel tailoring prediction models in a database. In the embodiment shown in FIG. 1, the one or more computing devices or servers store the channel routing classifier model and the channel tailoring prediction models in a database: multi-channel artificial intelligence (AI) models 161.

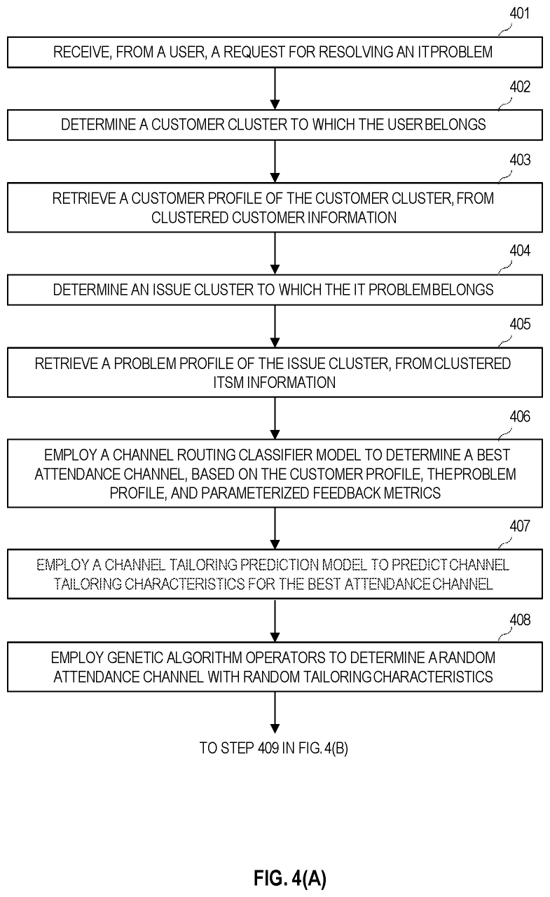

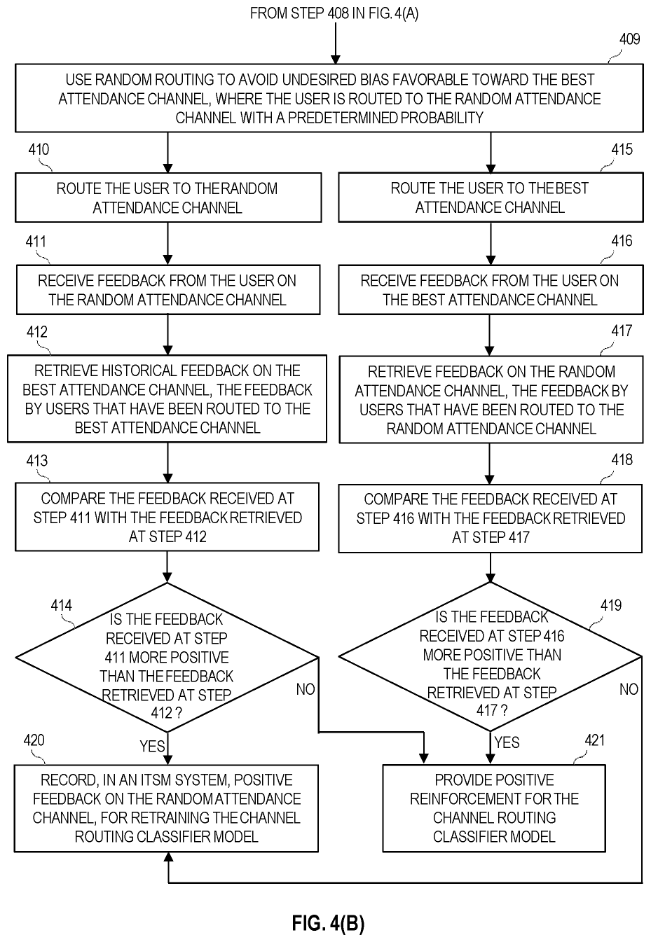

FIG. 4(A) and FIG. 4(B) show a flowchart showing operational steps of tailoring a multi-channel help desk environment, in accordance with one embodiment of the present invention. In the embodiment shown in FIG. 1, the operational steps of training machine learning models are implemented by tailoring a multi-channel help desk environment 130—a component in system 100 which is hosted on one or more computing devices or servers. A computing device or server is described in more detail in later paragraphs with reference to FIG. 5. The operational steps of training machine learning models may be implemented in a cloud computing environment. The cloud computing environment is described in more detail in later paragraphs with reference to FIG. 6 and FIG. 7.

At step 401, the one or more computing devices or server receive, from a user, a request for resolving an information technology (IT) problem. At this step, the one or more computing devices or server receive user information and the IT problem (or issue). At step 402, the one or more computing devices or server determine a customer cluster to which the user belongs. At this step, the one or more computing devices or server determine the customer cluster by computing a nearest customer cluster centroid. Once determining the customer cluster, at step 403, the one or more computing devices or server retrieve a customer profile of the customer cluster, from clustered customer information. In the embodiment shown in FIG. 1, the one or more computing devices or server retrieve the customer profile from clustered customer data 151.

At step 404, the one or more computing devices or server determine an issue cluster to which the IT problem belongs. At this step, the one or more computing devices or server determine the customer cluster by computing a nearest issue cluster centroid. At step 405, the one or more computing devices or server retrieve a problem profile of the issue cluster, from clustered ITSM information. In the embodiment shown in FIG. 1, the one or more computing devices or server retrieve the problem profile from clustered ITSM data 153.

At step 406, the one or more computing devices or server employ a channel routing classifier model to determine a best attendance channel, based on the customer profile, the problem profile, and parameterized feedback metrics. At this step, the one or more computing devices or server determines a most efficient help desk channel for resolving the IT problem of the user. The channel routing classifier model is a machine learning trained model. Training the channel routing classifier model is described in previous paragraphs with reference to FIG. 3.

At step 407, the one or more computing devices or server employ a channel tailoring prediction model to predict channel tailoring characteristics for the best attendance channel. At this step, the one or more computing devices or server determine tailoring parameters of the best attendance channel; the tailoring parameters may be, for example, chatbot skipping basic questions, web catalog displaying advanced fields, and so on. The channel tailoring prediction model is a machine learning trained model. Training channel routing classifier models is described in previous paragraphs with reference to FIG. 3.

At step 408, the one or more computing devices or server employ genetic algorithm operators to determine a random attendance channel with random tailoring characteristics. The genetic algorithm operators are randomized search algorithms and operate on string structures which are evolving in time. In every generation, a new set of strings is created, using parts of the fittest members of the old set. By employing such genetic algorithm operators, different combinations of attendance channels with their associated characteristics are obtained. At this step, the one or more computing devices or server generate random characteristics and recommend a divergent channel to the user with the IT issue.

At step 409, the one or more computing devices or server use random routing to avoid undesired bias favorable toward the best attendance channel, where the user is routed to the random attendance channel with a predetermined probability. If all users are routed to the best attendance channel every time, the one or more computing devices or server will not be able to collect enough user feedback about all the other available channels. This may distort the score of the best attendance channel and some channels may never be used. Therefore, to avoid all users are routed to the best attendance channel and get more feedback on other channels, the one or more computing devices or server randomly route the user to one of other channels (i.e., the random attendance channel). Randomly routing the user to the random attendance channel is with a predetermined probability (which is adjustable); for example, with 30% probability, the user may be routed to the random attendance channel.

At step 410, the one or more computing devices or server route the user to the random attendance channel. The user is provided with support by the random attendance channel. Upon completion of the support by the random attendance channel, at step 411, the one or more computing devices or server receive from the user feedback on the random attendance channel.

At step 412, the one or more computing devices or server retrieve feedback on the best attendance channel, where the feedback is by users that have been routed to the best attendance channel. At this step, the one or more computing devices or server retrieve the historical feedback on the best attendance channel. The historical feedback is retrieved from an ITSM system (e.g., ITSM system 147 shown in FIG. 1).

At step 413, the one or more computing devices or server compare the feedback on the random attendance channel (which is received from the user at step 411) with the feedback on the best attendance channel (which is retrieved from the ITSM system at step 412). Through the comparison, the one or more computing devices or server at step 414 determine whether the feedback on the random attendance channel received at step 411 is more positive than the feedback on the best attendance channel retrieved at step 412.

In response to determining that the feedback on the random attendance channel received at step 411 is more positive than the feedback on the best attendance channel retrieved at step 412 (YES branch of decision block 414), at step 420, the one or more computing devices or server records, in the ITSM system, positive feedback on the random attendance channel. The recorded positive feedback in the ITSM is used for retraining the channel routing classifier model.

In response to determining that the feedback on the random attendance channel received at step 411 is not more positive than the feedback on the best attendance channel retrieved at step 412 (NO branch of decision block 414), at step 421, the one or more computing devices or server provide positive reinforcement for the channel routing classifier model.

At step 415, the one or more computing devices or server route the user to the best attendance channel. The user is provided with support by the best attendance channel. Upon completion of the support by the best attendance channel, at step 416, the one or more computing devices or server receive from the user feedback on the best attendance channel.

At step 417, the one or more computing devices or server retrieve feedback on the random attendance channel, where the feedback is by users that have been routed to the random attendance channel. At this step, the one or more computing devices or server retrieve the historical feedback on the random attendance channel.

At step 418, the one or more computing devices or server compare the feedback on the best attendance channel (which is received from the user at step 416) with the feedback on the random attendance channel (which is retrieved from the ITSM system at step 417). Through the comparison, the one or more computing devices or server at step 419 determine whether the feedback on the best attendance channel received at step 416 is more positive than the feedback on the random attendance channel retrieved at step 417.

In response to determining that the feedback on the best attendance channel received at step 416 is more positive than the feedback on the random attendance channel retrieved at step 417 (YES branch of decision block 419), at step 421, the one or more computing devices or server provide positive reinforcement for the channel routing classifier model.

In response to determining that the feedback on the best attendance channel received at step 416 is not more positive than the feedback on the best attendance channel retrieved at step 417 (NO branch of decision block 419), at step 420, the one or more computing devices or server records, in the ITSM system, positive feedback on the random attendance channel. The recorded positive feedback in the ITSM is used for retraining the channel routing classifier model.

FIG. 5 is a diagram illustrating components of server 500, in accordance with one embodiment of the present invention. It should be appreciated that FIG. 5 provides only an illustration of one implementation and does not imply any limitations with regard to the environment in which different embodiments may be implemented.

Referring to FIG. 5, server 500 includes processor(s) 520, memory 510, and tangible storage device(s) 530. In FIG. 5, communications among the above-mentioned components of server 500 are denoted by numeral 590. Memory 510 includes ROM(s) (Read Only Memory) 511, RAM(s) (Random Access Memory) 513, and cache(s) 515. One or more operating systems 531 and one or more computer programs 533 reside on one or more computer readable tangible storage device(s) 530.

Server 500 further includes I/O interface(s) 550. I/O interface(s) 550 allows for input and output of data with external device(s) 560 that may be connected to server 500. Server 500 further includes network interface(s) 540 for communications between server 500 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of tailoring a multi-channel help desk environment based on machine learning models.

What is claimed is:

1. A computer-implemented method for training machine learning models for tailoring a multi-channel help desk environment, the method comprising:
analyzing customer feedback on attendance channels to obtain parameterized feedback metrics;
assembling a dataset including ticket records associated with the attendance channels and the parameterized feedback metrics;
augmenting the dataset by replacing customer identifications in the dataset with respective cluster centroids of customer clusters;
augmenting the dataset by replacing information technology (IT) descriptions in the dataset with respective cluster centroids of issue clusters;
training a machine learning model of selecting best attendance channels for respective ones of the customer clusters and for respective ones of the issue clusters, using an augmented dataset;
enhancing the augmented dataset by adding channel tailoring characteristics to the augmented dataset;
dividing an enhanced dataset into respective partitions for respective attendance channel types; and
training machine learning models of tailoring the respective attendance channel types, using the respective partitions of the enhanced dataset.

2. The computer-implemented method of claim 1, further comprising:
determining the channel tailoring characteristics, using data in an information technology service management (ITSM) system.

3. The computer-implemented method of claim 1, wherein the customer feedback and the ticket records are stored in an information technology service management (ITSM) system.

4. The computer-implemented method of claim 1, further comprising:
retrieving customer information from multiple sources;
retrieving, form an information technology service management (ITSM) system, ITSM information;
clustering the customer information to obtain customer profiles of the customer clusters; and
clustering the ITSM information to obtain problem profiles of the issue clusters.

5. The computer-implemented method of claim 4, wherein clustered customer information and clustered ITSM information are used for training the machine learning model of selecting best attendance channels and for training the machine learning models of tailoring the respective attendance channel types.

6. The computer-implemented method of claim 1, wherein, in training the machine learning model of selecting the best attendance channels, inputs are variables that represent customer profiles of the customer clusters, terms that represent problem profiles of the issue clusters, and the parameterized feedback metrics, wherein outputs are best attendance channels for respective ones of the customer clusters and respective ones of the issue clusters.

7. The computer-implemented method of claim 1, wherein, in training the machine learning models of tailoring the respective attendance channel types, inputs are variables that represent customer profiles of the customer clusters, terms that represent customer profiles of the customer clusters, and the parameterized feedback metrics, wherein outputs are channel tailoring characteristics for the respective attendance channel types.

8. The computer-implemented method of claim 1, further comprising:
storing the machine learning model of selecting the best attendance channels in a database; and
storing the machine learning models of tailoring the respective attendance channel types in the database.

9. The computer-implemented method of claim 1, further comprising:
in response to receiving a request from a user for resolving an IT problem, determining a customer cluster of the user;
determining an issue cluster of the IT problem;
employing the machine learning model of selecting the best attendance channels to determine a best attendance channel for resolving the IT problem of the user; and
employing one of the machine learning models of tailoring the respective attendance channel types to predict channel tailoring characteristics for the best attendance channel.

10. The computer-implemented method of claim 9, further comprising:
retrieving a customer profile of the customer cluster and a problem profile of the issue cluster; and
wherein employing the machine learning model of selecting the best attendance channels to determine the best attendance channel is based on the customer profile, the problem profile, and the parameterized feedback metrics.

11. A computer-implemented method for tailoring a multi-channel help desk environment based on machine learning models, the method comprising:
in response to receiving a request from a user for resolving an information technology (IT) problem, determining a customer cluster of the user;
determining an issue cluster of the IT problem;
employing a machine learning model of selecting best attendance channels to determine a best attendance channel for resolving the IT problem of the user;
employing a machine learning model of tailoring respective attendance channel types to predict channel tailoring characteristics for the best attendance channel;
employing genetic algorithm operators to determine a random attendance channel with random tailoring characteristics;
using random routing to route the user to one of the best attendance channel and the random attendance channel, routing the user to the random attendance channel with a predetermined probability; and
wherein using the random routing avoids undesired bias favorable toward the best attendance channel.

12. The computer-implemented method of claim 11, further comprising:
routing the user to the random attendance channel;
receiving, from the user, feedback on the random attendance channel;
retrieving, from an information technology service management (ITSM) system, historical feedback on the best attendance channel, the historical feedback by users that have been routed to the best attendance channel; and
comparing the feedback on the random attendance channel with the historical feedback on the best attendance channel.

13. The computer-implemented method of claim 12, further comprising:
in response to determining that the feedback on the random attendance channel is more positive than the historical feedback on the best attendance channel, recording, in the ITSM system, positive feedback on the random attendance channel; and
wherein the positive feedback on the random attendance channel is used for retraining the machine learning model of selecting the best attendance channels.

14. The computer-implemented method of claim 12, further comprising:
in response to determining that the feedback on the random attendance channel is not more positive than the historical feedback on the best attendance channel, providing positive reinforcement for the machine learning model of selecting the best attendance channels.

15. The computer-implemented method of claim 11, further comprising:
routing the user to the best attendance channel;
receiving, from the user, feedback on the best attendance channel;
retrieving, from an information technology service management (ITSM) system, historical feedback on the random attendance channel, the historical feedback by users that have been routed to the random attendance channel; and
comparing the feedback on the best attendance channel with the historical feedback on the random attendance channel.

16. The computer-implemented method of claim 15, further comprising:
in response to determining that the feedback on the best attendance channel is more positive than the historical feedback on the random attendance channel, providing positive reinforcement for the machine learning model of selecting the best attendance channels.

17. The computer-implemented method of claim 15, further comprising:
in response to determining that the feedback on the best attendance channel is not more positive than the historical feedback on the random attendance channel, recording, in the ITSM system, positive feedback on the random attendance channel; and
wherein the positive feedback on the random attendance channel is used for retraining the machine learning model of selecting the best attendance channels.

18. The computer-implemented method of claim 11, further comprising:
retrieving a customer profile of the customer cluster from clustered and a problem profile of the issue cluster; and
wherein employing the machine learning model of selecting the best attendance channels to determine the best attendance channel is based on the customer profile, the problem profile, and parameterized feedback metrics.

19. The computer-implemented method of claim 11, wherein tailoring the multi-channel help desk environment uses clustered information, wherein the clustered information is obtained by:
retrieving customer information from multiple sources;
retrieving, form an information technology service management (ITSM) system, ITSM information;
clustering the customer information to obtain customer profiles of customer clusters; and
clustering the ITSM information to obtain problem profiles of issue clusters.

20. The computer-implemented method of claim 11, wherein the machine learning model of selecting best attendance channels the and machine learning model of tailoring respective attendance channel are trained by inputting customer profiles of customer clusters, problem profiles of issue clusters, and parameterized feedback metrics.
